(19) United States
(12) Patent Application Publication
(10) Pub. No.: US 2013/0111313 A1
(43) Pub. Date: May 2, 2013

(54) Methods and Systems for Interactive Rendering of Multimedia Video in Response to Navigation Input

(71) Applicants: Francis A. Phan, San Francisco, CA (US); Alexx Henry, Los Angeles, CA (US)

(72) Inventors: Francis A. Phan, San Francisco, CA (US); Alexx Henry, Los Angeles, CA (US)

(21) Appl. No.: 13/662,359

(22) Filed: Oct. 26, 2012

Related U.S. Application Data
(60) Provisional application No. 61/553,815, filed on Oct. 31, 2011.

(51) Int. Cl. G06F 17/20

(52) U.S. Cl. CPC G06F 17/20
USPC 715/202

(57) ABSTRACT

Methods and systems for rendering a multimedia presentation on a device connected to the internet are provided. One method defines having a multimedia presentation illustrated on a page associated with a website served over the internet. The multimedia presentation is configured to be transferred to the device upon detection that the page of the website is accessed using the device. The multimedia file is a single multimedia file with a plurality of multimedia objects. The multimedia presentation is configured for rendering from an initial multimedia object and the multimedia presentation includes a logic graph that defines paths for traversing the plurality of multimedia objects of the single multimedia file in response to detected interfaces with one or more of the plurality of multimedia objects. The initial multimedia object is configured for presentation along with content of the page associated with the website. The content can include, in one example, online magazine content.

### CLAIM OF PRIORITY

This application claims the benefit of and priority to, under 35 U.S.C. 119§(e), to U.S. Provisional Patent Application No. 61/553,815, filed on Oct. 31, 2011, and titled “Methods and Systems for Interactive Rendering of Multimedia Video in Response to Navigation Input”, which is hereby incorporated by reference in its entirety.

### TECHNICAL FIELD

The present disclosure relates generally to methods and systems for displaying multimedia.

### BACKGROUND

The rapidly expanding presence of the Internet has produced an increased recognition of the importance of web advertising. As compared to more traditional media such as television or radio, advertising on the Web is based on web page views and is more easily quantifiable. In large part, each page view represents a transaction between a client (or user's) computer and a server. These individual client-server interactions permit more deterministic measures of the reach of particular advertising campaigns. Also, it is important that a user be able to view an advertisement in an efficient manner.

It is in this content that various embodiments of the present invention arise.

### SUMMARY

The following detailed description together with the accompanying drawings will provide a better understanding of the nature and advantages of various embodiments of the present invention.

In one embodiment, a method for displaying multimedia is described. In some embodiments, the method offers immersive and emotive experiences that serve as an extension to content that is displayed in a web page or a search result page.

In another embodiment, a method for rendering a multimedia presentation on a device connected to the internet is provided. This method defines having a multimedia presentation illustrated on a page associated with a website served over the internet. The multimedia presentation is configured to be transferred to the device upon detection that the page of the website is accessed using the device. The multimedia file is a single multimedia file with a plurality of multimedia objects. The multimedia presentation is configured for rendering from an initial multimedia object and the multimedia presentation includes a logic graph that defines paths for traversing the plurality of multimedia objects of the single multimedia file in response to detected interfaces with one or more of the plurality of multimedia objects. The initial multimedia object is configured for presentation along with content of the page associated with the website.

In an embodiment, a method for displaying multimedia is described. The method includes displaying a first multimedia. The method further includes determining whether a first input indicating a selection of the first multimedia is received. The method also includes displaying a second multimedia in response to receiving the first input. The second multimedia includes a first multimedia object and a second multimedia object. The method includes determining whether a second input indicating a selection of the first multimedia object or a third input indicating a selection of the second multimedia object is received. The method also includes displaying a third multimedia in response to determining that the second input is received. The method includes displaying a fourth multimedia in response to determining that the third input is received.

In another embodiment, a method for displaying multimedia is described. The method includes displaying a first multimedia. The first multimedia includes a first multimedia object and a second multimedia object. The method includes determining whether a first input indicating a selection of the first multimedia object or a second input indicating a selection of the second multimedia object is received. The method includes displaying a second multimedia in response to determining that the first input is received. The method also includes displaying a third multimedia in response to determining that the second input is received.

In one embodiment, a system for displaying multimedia is described. The system includes a display for displaying a first multimedia. The system further includes an input detector for detecting a first input. The first input is detected to detect a selection of the first multimedia. The display device is used for displaying a second multimedia in response to the detection of first input. The second multimedia includes a first multimedia object and a second multimedia object. The system includes a processor for determining whether a second input indicating a selection of the first multimedia object or a third input indicating a selection of the second multimedia object is received. The display is used for displaying a third multimedia in response to the determination that the second input is received. The display device is used for displaying a fourth multimedia in response to the determination that the third input is received.

### DESCRIPTION OF THE DRAWINGS

FIG. 1 is a flowchart of a method for displaying multimedia, in accordance with one embodiment of the present invention.

FIG. 2 is a flowchart of a method for displaying multimedia, in accordance with another embodiment of the present invention.

FIG. 3 is a flowchart of a method for displaying multimedia, in accordance with yet another embodiment of the present invention.

FIG. 4 is a flowchart of a method for displaying multimedia, in accordance with still another embodiment of the present invention.

FIG. 5A is a block diagram of an embodiment of a system for displaying a first multimedia, in accordance with one embodiment of the present invention.

FIG. 5B is a block diagram of an embodiment of a system for displaying a second multimedia, in accordance with one embodiment of the present invention.

FIG. 5C is a block diagram of an embodiment of a system for displaying a part of the second multimedia, in accordance with one embodiment of the present invention.

FIG. 5D is a block diagram of an embodiment of a system for displaying another part of the second multimedia, in accordance with one embodiment of the present invention.

FIG. 6 is a diagram illustrating a method of displaying multimedia by executing various portions of a multimedia file, in accordance with one embodiment of the present invention.

FIG. 7 is a block diagram illustrating a method of displaying multimedia by executing various portions of a multimedia file, in accordance with another embodiment of the present invention.

FIG. 8 is a diagram illustrating a method of displaying multimedia by executing various portions of a multimedia file, in accordance with another embodiment of the present invention.

FIG. 9 is a diagram illustrating a method of displaying multimedia by executing various portions of a multimedia file, in accordance with yet another embodiment of the present invention.

FIG. 10 is a diagram illustrating a method of displaying multimedia by executing various portions of a multimedia file, in accordance with still another embodiment of the present invention.

FIG. 11 shows an embodiment of a computing device, in accordance with another embodiment of the present invention.

### DETAILED DESCRIPTION

The following example embodiments and their aspects are described and illustrated in conjunction with apparatuses, methods, and systems which are meant to be illustrative examples, not limiting in scope.

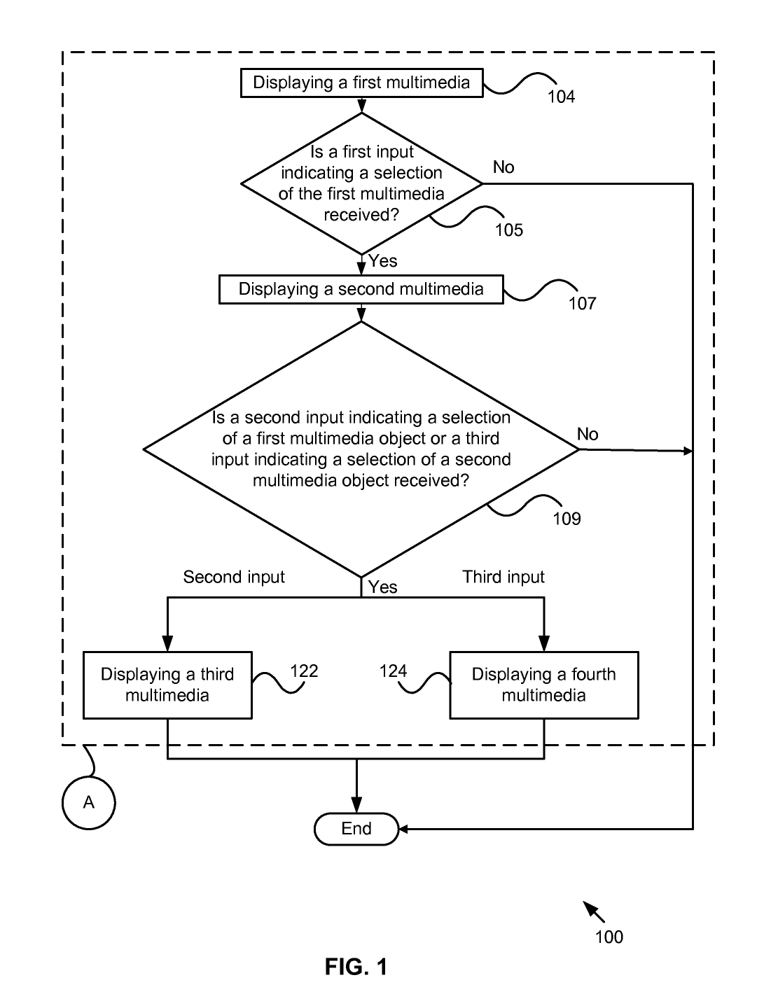

FIG. 1 is a flowchart of an embodiment of a method 100 for displaying multimedia. In one embodiment, the method 100 is performed using a computing device, such as a desktop computer, a laptop computer, a tablet personal computer, or a mobile phone. In operation 104, a first multimedia is displayed on a display screen. As used herein, a multimedia includes a series of frames. Each frame includes a number of graphical elements, such as, text data and image data. It should be noted that text data is rendered to display text on the display screen and image data is rendered to display an image on the display screen. In one embodiment, data, such as text data and image data, is in a compressed form, an uncompressed form, an encoded form, or a decoded form. In various embodiments, rendering is performed by a video interface, such as a video card, a video adapter, a graphics accelerator card, a display adapter, or a graphics card. In one embodiment, rendering is performed by a processor of the computing device. It should be noted that a processor, as used herein, includes a microprocessor, a central processing unit (CPU), a microcontroller, or an integrated circuit that performs processing operations. The processing operations are performed based on a set of instructions and data.

In various embodiments, the compression, decompression, coding, decoding, or combination thereof is performed by a video codec. In some embodiments, multimedia includes an animation; a video; a combination of animation and audio, a combination of audio, video, and text; a combination of audio, animation, and text; or a combination of video and audio.

In one embodiment, audio data is converted from a digital format to an analog format by one or more speakers to generate audio. In several embodiments, audio data is in a compressed form, a decompressed form, an encoded form, or a decoded form. An audio interface, such as an audio codec, is used to compress audio data, decompress audio data, encode audio data, decode audio data, or perform a combination thereof.

In some embodiments, multimedia is embedded within a web page.

In various embodiments, a frame has a pixel resolution of A pixels×B pixels, where each of A and B is an integer greater than zero. In one embodiment, a pixel resolution is measured in terms of pixels of the display screen of a display device. As used herein, a display device is a cathode ray tube, a liquid crystal display (LCD) device, a plasma display device, a light emitting diode (LED) display device, or any other type of display device. Moreover, as used herein, the display screen includes multiple display elements, such as, LED pixel elements or LCD pixel elements.

In some embodiments, the first multimedia is displayed by executing a first portion of a multimedia file. In one embodiment, a multimedia file is identified using a name of the file. For example, one multimedia file has a different name than another multimedia file. No two multimedia files have a same name. The processor identifies a multimedia file based on a name of the multimedia file. In various embodiments, a multimedia file is located in a directory. The directory includes any number of multimedia files. In one embodiment, the processor identifies and accesses a multimedia file with a name of the multimedia file and a path to a directory in which the multimedia file is located. In some embodiments, a name of a multimedia file is followed by an extension, such as .txt or .swf. An extension provides a type of a file. In some embodiments, a file type includes a video file, a text file, an image file, or an animation file. It should be noted that ‘txt’ is a short form for text and ‘swf’ is an acronym for small web format.

In some embodiments, the multimedia file is executed by a multimedia player software application, such as Adobe Flash player available from Adobe Systems Corporation, Adobe Integrated Runtime, which is also available from Adobe Systems, a hypertext markup language (HTML) based multimedia player, or a QuickTime player available from Apple Corporation. In various embodiments, a multimedia player software application is run by the processor. In other embodiments, a multimedia player software application is a browser plugin or a standalone application. In some embodiments, a multimedia file is an swf file, an HTML file, or an audio video interleave (AVI) file. As used herein, HTML includes a version of HTML, such as HTML4 or HTML5. In some embodiments, a portion of a multimedia file includes video data, animation data, image data, text data, or a combination thereof.

In operation 105, a determination is made whether a first input indicating a selection of the first multimedia is received. A determination of whether an input is received is made by the processor. An example of a selection of a multimedia includes a touch of a screen or a click on an input device. In some embodiments, an input device is a mouse, a keyboard, or a stylus. In various embodiments, the screen touch is performed with a stylus, a finger of a user, or a thumb of a user. In some embodiments, an input includes a digital signal, which is generated from an analog signal. The analog signal is generated by an input detector, such as, a capacitor or a resistor. In one embodiment, an input includes a digital signal generated by an input device.

In various embodiments, an input detector generates an analog signal in response to detecting a touch of a display screen by a user. In some embodiments, an input device generates a digital signal in response to a selection of a button, such as a mouse button or a keyboard button.

In response to determining that there is a lack of reception of the first input, the method 100 ends. On the other hand, in response to determining that the first input is received, a second multimedia is displayed on the display screen in operation 107. The display of the second multimedia replaces the display of the first multimedia. In some embodiments, the display of the second multimedia replaces a display of the web page on which the first multimedia is displayed. In one embodiment, the second multimedia is displayed by executing a second portion of the same multimedia file, which is executed to generate the first multimedia. In some embodiments, the second portion is other than the first portion. For example, the first portion is described within a first unordered list (ul) element of an HTML video file and the second portion is described within a second ul element of the HTML video file. As another example, the first portion is described within a first element of an swf file and the second portion is described within a second element of the swf file. As yet another example, the first portion is defined in a first set of lines of software code of a multimedia file other than a second set of lines of software code of the multimedia file. The second set of lines defines the second portion.

In some embodiments, all graphical elements of the second portion are included within the first portion. In other embodiments, one or more graphical elements of the second portion are excluded from the first portion. In several embodiments, the first portion includes a loop operation and the second portion is a non-loop operation. In some embodiments, a loop operation is executed endlessly until the first portion is displayed. In one embodiment, a loop operation is executed for a limited number of times. In some embodiments, a portion of the multimedia file is a loop operation. In other embodiments, a portion of the multimedia file is a non-loop operation. In several embodiments, all audio data of the second portion is included within the first portion. It should be noted that audio data is converted from a digital format to an analog format to generate a sound. In some embodiments, at least one audio datum of the second portion is excluded from the first portion.

The second multimedia includes one or more multimedia objects, such as a first multimedia object and a second multimedia object. A multimedia object is displayed by executing a subportion, within the second portion. A subportion is a logical group formed to receive a selection from a user. In some embodiments, a subportion includes a div element of an HTML file or an ul element of the HTML file. For example, a subportion is executed to display, on the display screen, an overlay on the display screen. When a user sees an overlay, the user may select a section, on the display screen, within the overlay. In one embodiment, an overlay includes an animation that changes size with time or does not change size. In another embodiment, an overlay includes a static image or a video. An overlay is overlayed on a multimedia object. For example, an animation is overlayed on a multimedia object. In some embodiments, an overlay is displayed for a portion of time during which a multimedia object is displayed. In other embodiments, an overlay is displayed for an entire time during which a multimedia object is displayed.

In some embodiments, overlay data is coded in a programming language, such as C++ or Javascript. The overlay data is rendered by the processor to display an overlay. In some embodiments, the overlay data is stored in a multimedia cache system (MCS), which is further described below.

In one embodiment, the first multimedia object includes a first subportion of the second portion and the second subportion of the second multimedia object includes a second subportion of the second portion. For example, the first subportion includes a first div element of an HTML file and the second subportion includes a second div element of the HTML file. As another example, the first subportion includes lines of software code of the second portion other than lines of software code of the second subportion.

In operation 109, it is determined whether a second input indicating a selection of the first multimedia object or a third input indicating a selection of the second multimedia object is received. The operation 109 is performed by the processor. In some embodiments, a selection of the first multimedia object or a selection of the second multimedia object is made by a user. In some embodiments, the user touches the first multimedia object on the display screen to select the first multimedia object or touches the second multimedia object on the display screen to select the second multimedia object. In other embodiments, the user scrolls a mouse on a mousepad to locate a cursor at the first multimedia object and selects the mouse button to select the first multimedia object. In some embodiments, the user scrolls a mouse on a mousepad to locate a cursor at the second multimedia object and selects the mouse button to select the second multimedia object. In response to determining that none of the second and third inputs are received, the method 100 ends.

On the other hand, upon determining that the second input is received, in operation 122, a third multimedia is displayed on the display screen. The display of the third multimedia replaces the display of the second multimedia. In one embodiment, the third multimedia is displayed by executing a third portion of the same multimedia file, which is executed to generate the first and second multimedia. In some embodiments, the third portion is other than the second portion and other than the first portion. For example, the first portion is described within the first ul element of an HTML video file, the second portion is described within the second ul element of the HTML video file and the third portion is described within a third ul element of the HTML video file. As another example, the first portion is described within the first element of an swf file, the second portion is described within the second element of the swf file and the third portion is described within a third element of the swf file. As yet another example, the second portion is defined in the second set of lines of software code of a multimedia file other than a third set of lines of software code of the multimedia file. The third set of lines defines the third portion. Moreover, the first portion is defined in the first set of lines of software code of the multimedia file other than the third set of lines.

Moreover, upon determining that the third input is received, a fourth multimedia is displayed on the display screen. The display of the fourth multimedia replaces the display of the second multimedia. In one embodiment, the fourth multimedia is displayed by executing a fourth portion of the same multimedia file, which is executed to generate the first, second and third multimedia. In some embodiments, the fourth portion is other than the third portion, other than the second portion, and other than the first portion. For example, the first portion is described within the first ul element of an HTML video file, the second portion is described within the second ul element of the HTML video file, the third portion is described within the third ul element of the HTML video file, and the fourth portion is described within a fourth ul element of the HTML video file. As another example, the first portion is described within the first element of an swf file, the second portion is described within the second element of the swf file, the third portion is described within the third element of the swf file, and the fourth portion is described within a fourth element of the swf file. As yet another example, the third portion is defined in the third set of lines of software code of a multimedia file other than a fourth set of lines of software code of the multimedia file. The fourth set of lines define the fourth portion. Moreover, the first portion is defined in the first set of lines of software code of the multimedia file other than the fourth set of lines. Also, the second portion is defined in the second set of lines of software code of the multimedia file other than the fourth set of lines.

In various embodiments, a multimedia is generated by executing one or more portions of one or more multimedia files.

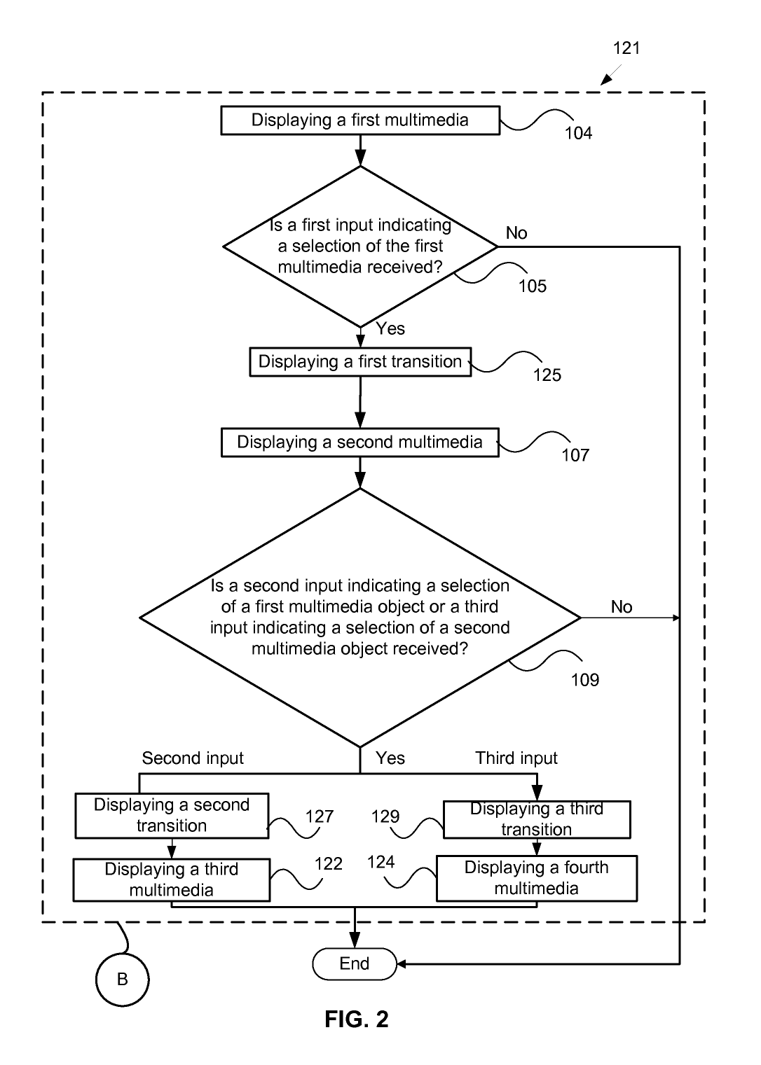

FIG. 2 is a flowchart of an embodiment of a method 121 for displaying multimedia. The method 121 is performed by the computing device. The operations 104 and 105 are performed. Moreover, in operation 125, a first transition is displayed on the display screen. A transition is a transition between a current multimedia and a next multimedia. In one embodiment, a display of a transition between the current multimedia and the next multimedia precedes the next multimedia. Moreover, in such an embodiment, the current multimedia precedes the transition. In one embodiment, a transition is a multimedia. In various embodiments, a number of graphical elements executed to display a transition between the current multimedia and next multimedia is less than a number of graphical elements executed to display the current or next multimedia. In other embodiments, a number of graphical elements executed to display a transition between the current multimedia and next multimedia is equal to or more than a number of graphical elements executed to display the current or next multimedia. In various embodiments, one or more graphical elements executed to display a transition, which is between the current multimedia and next multimedia, are the same as one or more graphical elements executed to display the current multimedia. In some embodiments, one or more graphical elements executed to display a transition, which is between the current multimedia and next multimedia, are the same as one or more graphical elements executed to display the next multimedia.

In several embodiments, the first transition is displayed by executing a fifth portion of the same multimedia file, which is executed to generate the first, second, third, and fourth multimedia. In some embodiments, the fifth portion is other than the fourth portion, other than the third portion, other than the second portion, and other than the first portion. For example, the first portion is described within the first ul element of an HTML video file, the second portion is described within the second ul element of the HTML video file, the third portion is described within the third ul element of the HTML video file, the fourth portion is described within the fourth ul element of the HTML video file, and the fifth portion is described within a fifth ul element of the HTML video file.

As another example, the first portion is described within the first element of an swf file, the second portion is described within the second element of the swf file, the third portion is described within the third element of the swf file, the fourth portion is described within the fourth element of the swf file, and the fifth portion is described within a fifth element of the swf file. As yet another example, the fourth portion is defined in the fourth set of lines of software code of a multimedia file other than a fifth set of lines of software code of the multimedia file. The fifth set of lines define the fifth portion. Moreover, the first portion is defined in the first set of lines of software code of the multimedia file other than the fifth set of lines. Also, the second portion is defined in the second set of lines of software code of the multimedia file other than the fifth set of lines. The third portion is defined in the third set of lines of software code of the multimedia file other than the fifth set of lines.

Also, it should be noted that in some embodiments, there is a lack of transition between the current multimedia and the next multimedia.

Moreover, operations 107 and 109 are performed. Upon determining that the second input is received, in operation 127, a second transition between the second multimedia and the third multimedia is displayed on the display screen. In several embodiments, the second transition is displayed by executing a sixth portion of the same multimedia file, which is executed to generate the first multimedia, second multimedia, third multimedia, fourth multimedia, and the first transition. In some embodiments, the sixth portion is other than the fifth portion, other than the fourth portion, other than the third portion, other than the second portion, and other than the first portion. For example, the first portion is described within the first ul element of an HTML video file, the second portion is described within the second ul element of the HTML video file, the third portion is described within the third ul element of the HTML video file, the fourth portion is described within the fourth ul element of the HTML video file, the fifth portion is described within the fifth ul element of the HTML video file, and the sixth portion is described within a sixth ul element of the HTML video file.

As another example, the first portion is described within the first element of an swf file, the second portion is described within the second element of the swf file, the third portion is described within the third element of the swf file, the fourth portion is described within the fourth element of the swf file, the fifth portion is described within the fifth element of the swf file, and the sixth portion is described within a sixth element of the swf file.

As yet another example, the fifth portion is defined in the fifth set of lines of software code of a multimedia file other than a sixth set of lines of software code of the multimedia file. The sixth set of lines defines the sixth portion. Moreover, the first portion is defined in the first set of lines of software code of the multimedia file other than the sixth set of lines. Also, the second portion is defined in the second set of lines of software code of the multimedia file other than the sixth set of lines. The third portion is defined in the third set of lines of software code of the multimedia file other than the sixth set of lines. The fourth portion is defined in the fourth set of lines of software code of the multimedia file other than the sixth set of lines.

Furthermore, the operation 122 is performed. Upon determining that the third input is received, in operation 129, a third transition between the second multimedia and the fourth multimedia is displayed on the display screen. In several embodiments, the third transition is displayed by executing a seventh portion of the same multimedia file, which is executed to generate the first multimedia, second multimedia, third multimedia, fourth multimedia, the first transition, and the second transition. In some embodiments, the seventh portion is other than the sixth portion, other than the fifth portion, other than the fourth portion, other than the third portion, other than the second portion, and other than the first portion. For example, the first portion is described within the first ul element of an HTML video file, the second portion is described within the second ul element of the HTML video file, the third portion is described within the third ul element of the HTML video file, the fourth portion is described within the fourth ul element of the HTML video file, the fifth portion is described within the fifth ul element of the HTML video file, the sixth portion is described within a sixth ul element of the HTML video file, and the seventh portion is described within a seventh ul element of the HTML video file. As another example, the first portion is described within the first element of an swf file, the second portion is described within the second element of the swf file, the third portion is described within the third element of the swf file, the fourth portion is described within the fourth element of the swf file, the fifth portion is described within the fifth element of the swf file, the sixth portion is described within the sixth element of the swf file, and the seventh portion is described within a seventh element of the swf file.

As yet another example, the sixth portion is defined in the sixth portion set of lines of software code of a multimedia file other than a seventh set of lines of software code of the multimedia file. The seventh set of lines defines the seventh portion. Moreover, the first portion is defined in the first set of lines of software code of the multimedia file other than the seventh set of lines. Also, the second portion is defined in the second set of lines of software code of the multimedia file other than the seventh set of lines. The third portion is defined in the third set of lines of software code of the multimedia file other than the seventh set of lines. The fourth portion is defined in the fourth set of lines of software code of the multimedia file other than the seventh set of lines. The fifth portion is defined in the fifth set of lines of software code of the multimedia file other than the seventh set of lines.

Moreover, operation 124 is performed. The method 121 ends after operations 122 or 124.

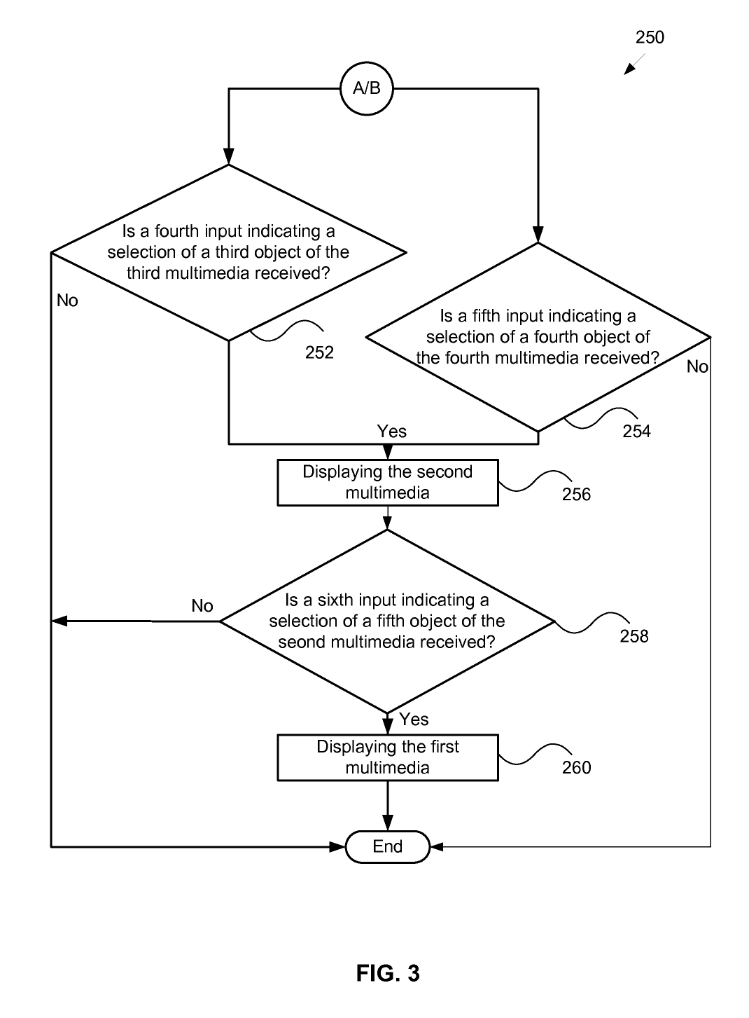

FIG. 3 is a flowchart of an embodiment of a method 250 for displaying multimedia. The method 250 is performed by the computing device. In operation 252, it is determined whether a fourth input indicating a selection of a third object of the third multimedia received. An example of the third object includes a close symbol that allows a graphical window to be closed. In this example, the third multimedia is displayed within the graphical window. When a graphical window is closed, a multimedia or a transition within the graphical window is not displayed by the display screen. Upon determining that there is lack of reception of the fourth input, the method 250 ends.

Moreover, in operation 254, it is determined whether a fifth input indicating a selection of a fourth object of the third multimedia received. An example of the fourth object includes a close symbol that allows closure of a window in which the fourth multimedia is displayed. Upon determining that there is lack of reception of the fifth input, the method 250 ends.

On the other hand, upon determining that there is reception of the fourth input or the fifth input, in operation 256, the second multimedia is displayed on the display screen to replace the display, in operation 252, of the third multimedia or the display, in operation 254, of the fourth multimedia. In some embodiments, instead of the second multimedia, a part of the second multimedia is displayed on the display screen. The second multimedia includes a fifth object. An example of the fifth object includes a close symbol that allows closure of a window in which the second multimedia is displayed.

In operation 258, it is determined whether a sixth input indicating a selection of the fifth object is received. In response to determining that there is a lack of reception of the sixth input, the method 250 ends. On the other hand, upon determining that the sixth input is received, in operation 260, the first multimedia is displayed on the display screen to replace the second multimedia, which is displayed in operation 256. The method 250 ends after operation 260.

It should be noted that the method 250 is performed after performing the operations 122 or 124 of the method 100 (FIG. 1). In some embodiments, the method 25 is performed after performing the operations 122 or 124 of the method 121.

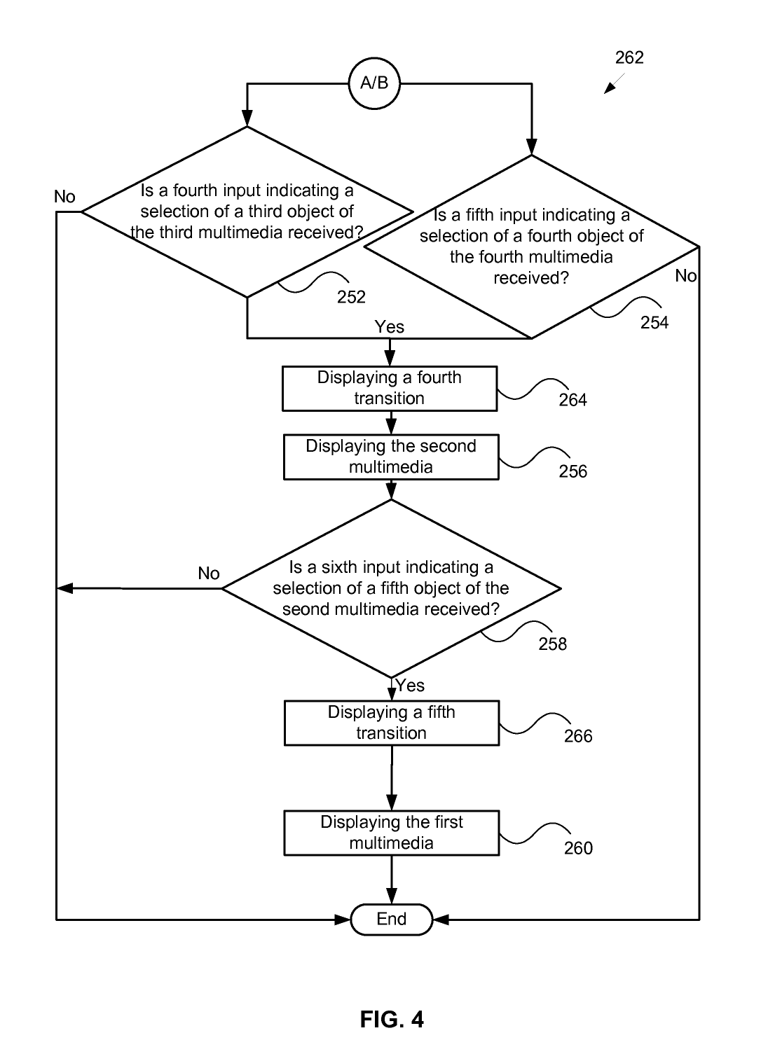

FIG. 4 is a flowchart of an embodiment of a method 262 for displaying multimedia. The method 262 is performed by the computing device.

Moreover, the operations 252 and 254 are performed. In operation 264, a fourth transition between the third multimedia and the second multimedia is displayed on the display screen. In several embodiments, the fourth transition is displayed by executing an eighth portion of the same multimedia file, which is executed to generate the first multimedia, second multimedia, third multimedia, fourth multimedia, the first transition, the second transition, and the third transition.

In some embodiments, the eighth portion is other than the seventh portion, other than the sixth portion, other than the fifth portion, other than the fourth portion, other than the third portion, other than the second portion, and other than the first portion. For example, the first portion is described within the first ul element of an HTML video file, the second portion is described within the second ul element of the HTML video file, the third portion is described within the third ul element of the HTML video file, the fourth portion is described within the fourth ul element of the HTML video file, the fifth portion is described within the fifth ul element of the HTML video file, the sixth portion is described within the sixth ul element of the HTML video file, the seventh portion is described within the seventh ul element of the HTML video file, and the eighth portion is described within an eighth ul element of the HTML video file. As another example, the first portion is described within the first element of an swf file, the second portion is described within the second element of the swf file, the third portion is described within the third element of the swf file, the fourth portion is described within the fourth element of the swf file, the fifth portion is described within the fifth element of the swf file, the sixth portion is described within the sixth element of the swf file, the seventh portion is described within the seventh element of the swf file, and the eighth portion is described within the eighth element of the swf file.

As yet another example, the seventh portion is defined in the seventh set of lines of software code of a multimedia file other than an eighth set of lines of software code of the multimedia file. The eighth set of lines defines the eighth portion. Moreover, the first portion is defined in the first set of lines of software code of the multimedia file other than the eighth set of lines. Also, the second portion is defined in the second set of lines of software code of the multimedia file other than the eighth set of lines. The third portion is defined in the third set of lines of software code of the multimedia file other than the eighth set of lines. The fourth portion is defined in the fourth set of lines of software code of the multimedia file other than the eighth set of lines. The fifth portion is defined in the fifth set of lines of software code of the multimedia file other than the eighth set of lines. The sixth portion is defined in the sixth set of lines of software code of the multimedia file other than the eighth set of lines. Operations 256 and 258 are performed.

In operation 266, a fifth transition between the second multimedia, displayed in operation 266, and the first multimedia is displayed on the display screen. In several embodiments, the fifth transition is displayed by executing a ninth portion of the same multimedia file, which is executed to generate the first multimedia, second multimedia, third multimedia, fourth multimedia, the first transition, the second transition, the third transition, and the fourth transition.

In some embodiments, the ninth portion is other than the eighth portion, other than the seventh portion, other than the sixth portion, other than the fifth portion, other than the fourth portion, other than the third portion, other than the second portion, and other than the first portion. For example, the first portion is described within the first ul element of an HTML video file, the second portion is described within the second ul element of the HTML video file, the third portion is described within the third ul element of the HTML video file, the fourth portion is described within the fourth ul element of the HTML video file, the fifth portion is described within the fifth ul element of the HTML video file, the sixth portion is described within the sixth ul element of the HTML video file, the seventh portion is described within the seventh ul element of the HTML video file, the eighth portion is described within the eighth ul element of the HTML video file, and the ninth portion is described within the ninth ul element of the HTML video file. As another example, the first portion is described within the first element of an swf file, the second portion is described within the second element of the swf file, the third portion is described within the third element of the swf file, the fourth portion is described within the fourth element of the swf file, the fifth portion is described within the fifth element of the swf file, the sixth portion is described within the sixth element of the swf file, the seventh portion is described within the seventh element of the swf file, the eighth portion is described within the eighth element of the swf file, and the ninth portion is described within a ninth element of the swf file.

As yet another example, the eighth portion is defined in the eighth set of lines of software code of a multimedia file other than a ninth set of lines of software code of the multimedia file. The ninth set of lines defines the ninth portion. Moreover, the first portion is defined in the first set of lines of software code of the multimedia file other than the ninth set of lines. Also, the second portion is defined in the second set of lines of software code of the multimedia file other than the ninth set of lines. The third portion is defined in the third set of lines of software code of the multimedia file other than the ninth set of lines. The fourth portion is defined in the fourth set of lines of software code of the multimedia file other than the ninth set of lines. The fifth portion is defined in the fifth set of lines of software code of the multimedia file other than the ninth set of lines. The sixth portion is defined in the sixth set of lines of software code of the multimedia file other than the ninth set of lines. The seventh portion is defined in the seventh set of lines of software code of the multimedia file other than the ninth set of lines.

Moreover, operation 260 is performed and the method 252 ends after performing the operation 260.

It should be noted that although the flowcharts are described with a sequence of operations, in various embodiments, operations in a flowchart are performed in a different sequence than that show or are performed in parallel.

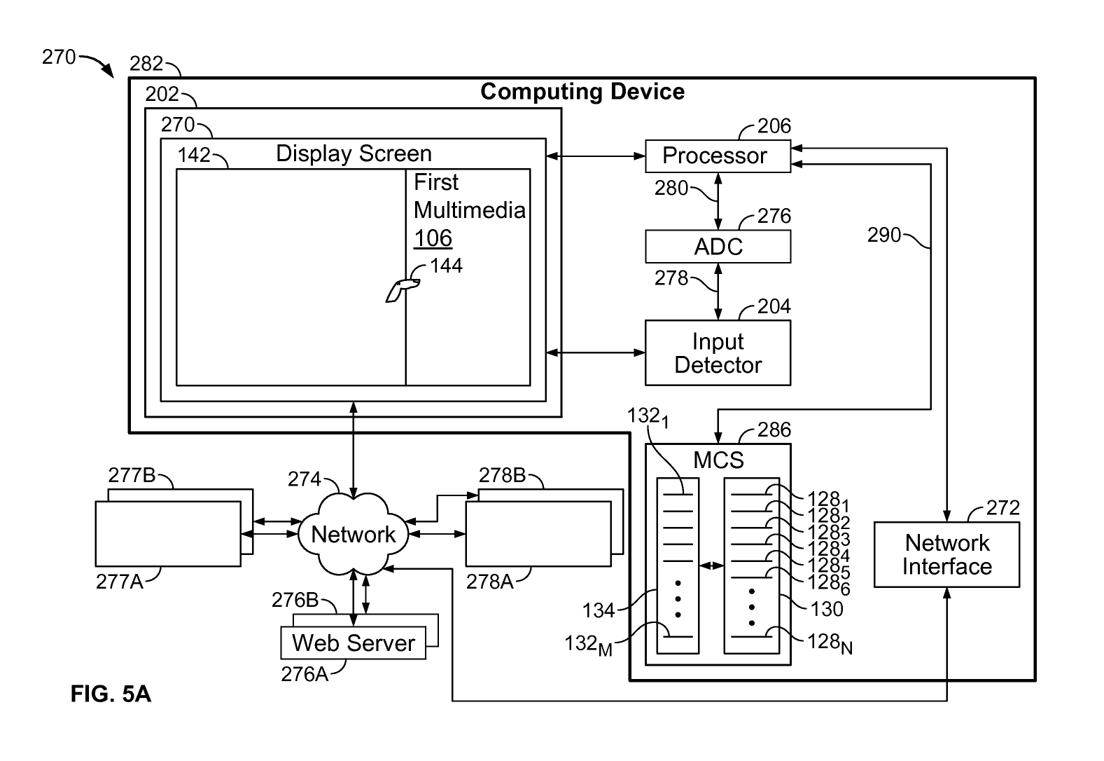

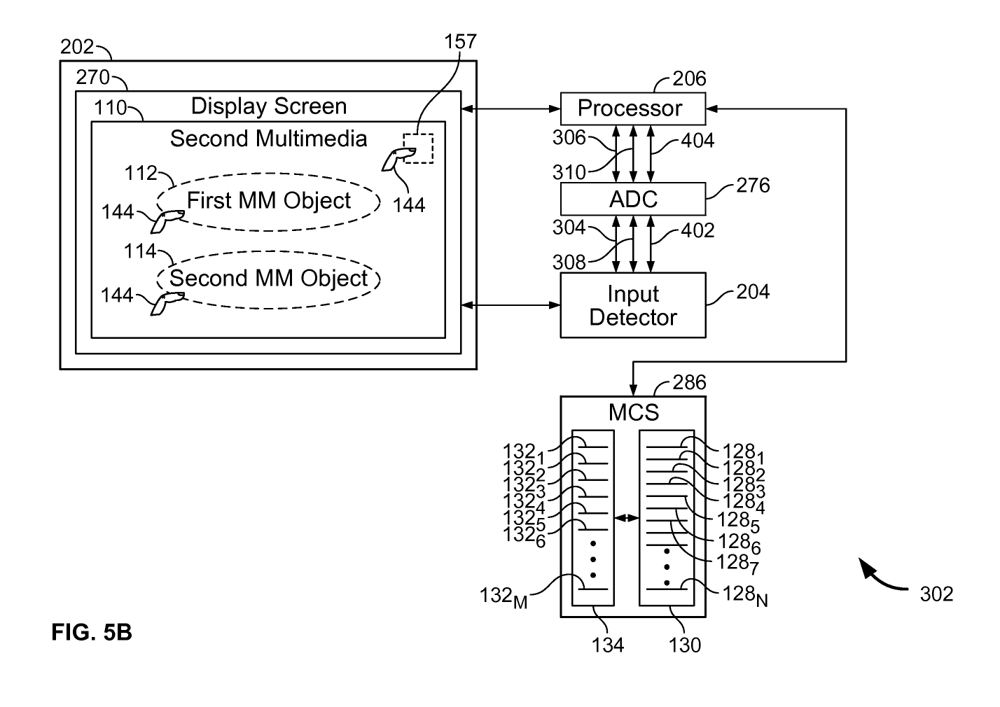

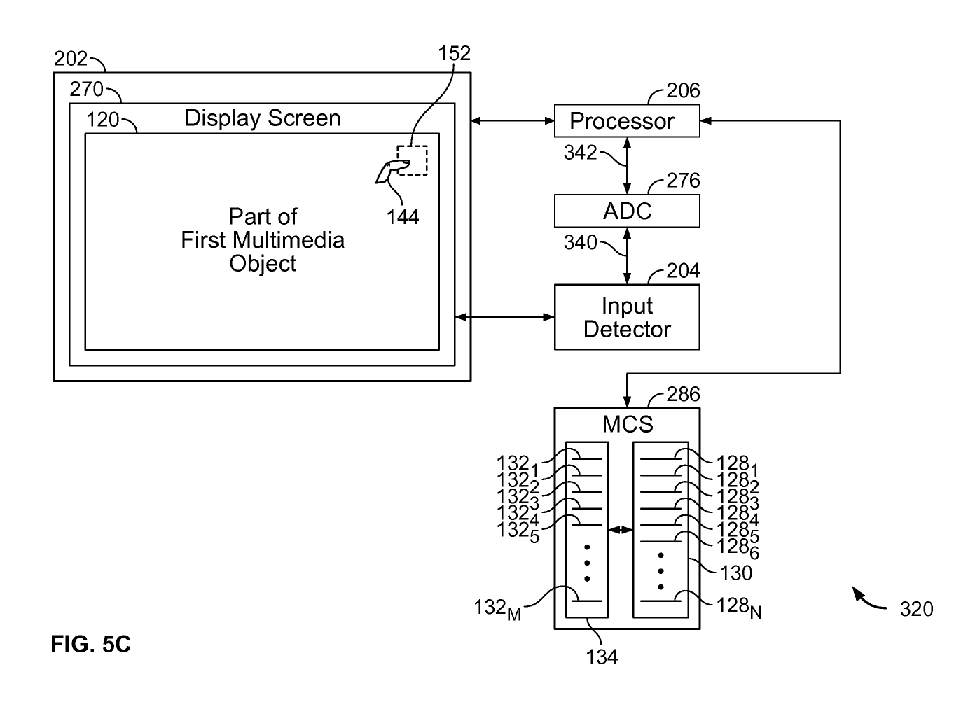

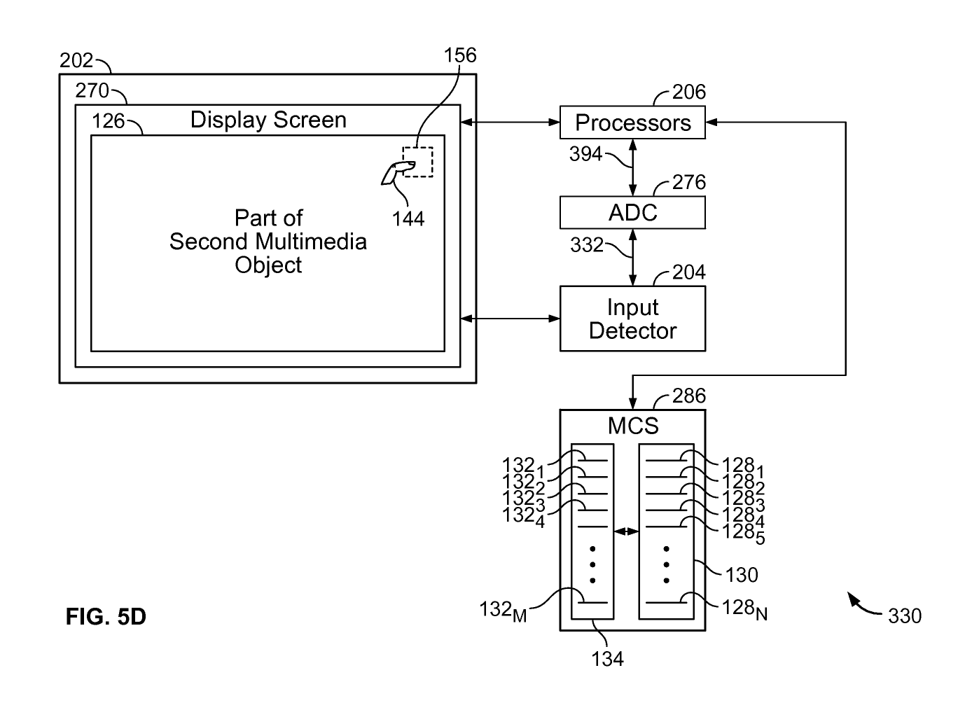

FIG. 5A is a block diagram of an embodiment of a system 270 for displaying a first multimedia 106. Processor 206 sends a web page request to request web page data. The web page request is sent via a network interface 272 and a network 274 to a web server 276A. The web page data corresponds to a web page 142 in that the web page data is rendered to display the web page 142 on a display screen 270 of a display device 202. The network interface 272 allows processor 206 to communicate with various devices of a network 274 and various devices coupled with the network 274. In one embodiment, the network 274 includes a local area network (LAN), such as an Intranet, or a wide area network (WAN), such as the Internet. In some embodiments, the network interface 272 includes a network interface card (NIC) or a modem.

The web server 276A receives the web page request from the processor 206 and sends the web page data to the processor 206 in response to the request. Processor 206 receives the web page data via the network 274 and the network interface 272.

In some embodiments, instead of a web page request, the processor 206 sends a search request to one or more servers 277. The search request is generated in response to a keyword query made by a user via an input device. The keyword query is received by the processor 206 when the processor 206 executes a search engine, such as one available from Yahoo Corporation or other companies. Upon receiving the search request, the one or more servers 277 send search result data to the processor 206. In one embodiment, the search result data includes one or more hyperlinks to one or more web sites. Processor 206 renders the search result data to display a search results page on the display screen 270. The search results page is displayed on display screen 270 instead of the web page 142.

When the web page data is received, the processor 206 sends a multimedia request to an MCS 286 to request multimedia data that is stored in the MCS 286. In one embodiment, the multimedia data includes image data, animation data, video data, text data, or a combination thereof. In some embodiments, the MCS 286 includes one or more memory caches. Video data is rendered by the processor 206 to display a video on display screen 270. Moreover, animation data is rendered by the processor 206 to display an animation on display screen 270.

In one embodiment, the multimedia data, stored in MCS 286, is distributed in portions 128₁, 128₂, 128₃, 128₄ until 128_{N} of a multimedia file 130, where the subscript N is an integer greater than zero. In several embodiments, the multimedia data is distributed in any number of portions of the multimedia file 130.

Moreover, one or more instructions 132₁, 132₂, 132₃, 132₄ until 132ₘ indicating one or more associations between a portion of the multimedia file 130 and one or more of the remaining portions of the multimedia file 130 are stored in MCS 286, where the subscript M is an integer greater than zero. For example, an instruction to execute portion 128₂ is executed when an input indicating a selection of a multimedia that is generated by rendering the portion 128₁ is received. As another example, an instruction to execute portion 128₃ is stored in the MCS 286. In this example, the instruction is executed when an input is received. In this example, the input indicates a selection of the first multimedia object that is generated by rendering the portion 128₂. As yet another example, an instruction to execute portion 128₄ is stored in the MCS 286. In this example, the portion 128₄ is executed when an input is received. In the example, the input indicates a selection of the second multimedia object of multimedia that is generated by rendering the portion 128₂. In some embodiments, an association between each portion of the multimedia file 130 and one or more of the remaining portions of the multimedia file 130 is stored in a memory device that is other than the MCS 286. As used herein, a memory device includes a read-only memory (ROM), a random access memory (RAM), or a combination of the ROM and RAM. The instructions 132₁, 132₂, 132₃, 132₄ until 132_{M} are located in an instruction set 134.

In some embodiments, in response to a cache miss, the multimedia request is sent via network interface 272 and network 274 to one or more servers 278. In response to receiving the multimedia request, the one or more servers 278 communicate the instruction set 134 and the multimedia file 130 to processor via network 274 and network interface 272. Processor 206 stores the instruction set 134 and the multimedia file 130 in the MCS 286 upon receiving the instruction set 134 and the multimedia file 130 via the network 274.

In several embodiments, the multimedia file 130 is created by one or more entities. The one or more entities use one or more servers 278 to create the multimedia file 130. As used herein, an entity is a person or an organization. In some embodiments, the instruction set 134 is created by one or more entities by using one or more servers 278.

In several embodiments, the MCS 286 also includes one or more associations between the web page data and a portion of the multimedia file 130. For example, an ad tag is stored in the MCS 286. In the example, the ad tag identifies the portion 128₁. When the web page data is rendered by the processor 206 to display the web page 142, the portion 128₁ is also executed by the processor 206 to render first multimedia 106 on the web page 142.

In one embodiment, the multimedia data is advertisement data. The advertisement data is rendered by the processor 206 to display one or more advertisements on display screen 270. In one embodiment, an advertisement is used to persuade one or more users to take some action with respect to products, services, ideas, or a combination thereof. For example, an advertiser usually prefers that one or more users purchase or lease a product, service, or an idea offered by the advertiser. A description of the product, service, or idea is displayed to a user in an advertisement.

A user selects first multimedia 106 by touching a section of display screen 270 with a finger 144. The first multimedia 106 is displayed in the section. Input detector 204 generates a detection signal 278 in response to determining that the selection of first multimedia 106 is made. An analog-to-digital converter (ADC) 276 converts the detection signal 278 from an analog form to a digital form to generate an input signal 280. Processor 206 receives the input signal 280 and executes the instruction 132₁ to determine to display a second multimedia 110, which is shown in FIG. 5B.

It should be noted that the processor 206, display device 202, ADC 276, input detector 204, MCS 286, and network interface 272 are components of a computing device 282. Moreover, it should be noted that in some embodiments in which a digital signal is received from an input device, there is no need to implement or use the ADC 276.

FIG. 5B is a block diagram of an embodiment of a system 302 for displaying the second multimedia 110. The second multimedia 110 includes an object 157. In one embodiment, the object 157 includes a close object that allows the user to end a display of second multimedia 110 on display screen 270. In various embodiments, the object 157 is a close icon.

Processor 206 executes the instruction 132₁ to determine to execute the portion 128₂. When portion 128₂ is executed by the processor 206, the second multimedia 110 is rendered on display screen 270. The second multimedia 110 includes a first multimedia object 112 and a second multimedia object 114.

The user may select the first multimedia object 112 by touching a section of display screen 270 with finger 144. The first multimedia object 112 is displayed in the section. Input detector 204 generates a detection signal 304 in response to determining that the selection of first multimedia object 112 is made. The ADC 276 converts the detection signal 304 from an analog form to a digital form to generate an input signal 306. Processor 206 receives the input signal 306 and executes the instruction 132₂ to determine to display a part 120 of the first multimedia object 112. The part 120 is shown in FIG. 5C.

Moreover, instead of the first multimedia object 112, the user may select the second multimedia object 114 by touching a section of display screen 270 with finger 144. The second multimedia object 114 is displayed in the section. Input detector 204 generates a detection signal 308 in response to determining that the selection of second multimedia object 114 is made. The ADC 276 converts the detection signal 308 from an analog form to a digital form to generate an input signal 310. Processor 206 receives the input signal 310 and executes the instruction 132₃ to determine to display a part 126 of the second multimedia object 114. The part 126 is shown in FIG. 5D.

FIG. 5C is a block diagram of an embodiment of a system 320 for displaying the part 120. In several embodiments, instead of the part 120, the first multimedia object 112 is displayed. Processor 206 executes the instruction 132₂ to determine to execute the portion 128₃. When portion 128₃ is executed by the processor 206, the part 120 is rendered on display screen 270. The part 120 includes an object 152. In one embodiment, the object 152 includes a close object that allows the user to end a display of part 120 on display screen 270. In various embodiments, the object 152 is a close icon.

FIG. 5D is a block diagram of an embodiment of a system 330 for displaying the part 126. In several embodiments, instead of the part 126, the second multimedia object 114 is displayed. Processor 206 executes the instruction 132₃ to determine to execute the portion 128₄. When portion 128₄ is executed by the processor 206, the part 126 is rendered on display screen 270. The part 126 includes an object 156. In one embodiment, the object 156 includes a close object that allows the user to end a display of part 126 on display screen 270. In various embodiments, the object 156 is a close icon.

A user selects object 156 by touching a section of display screen 270 with finger 144. The object 156 is displayed in the section. Input detector 204 generates a detection signal 332 in response to determining that the selection of object 156 is made. An analog-to-digital converter (ADC) 276 converts the detection signal 332 from an analog form to a digital form to generate an input signal 394.

Processor 206 receives the input signal 394 and executes the instruction 132₄ to determine to display the second multimedia 110, which is shown in FIG. 5B. Upon executing the instruction 132₄, the processor 206 is directed to execute the portion 128₂. Processor 206 executes the portion 128₂ to display the second multimedia 110 on display screen 270.

In some embodiments, processor 206 receives the input signal 294 and executes the instruction 132₄ to determine to display one or more parts of the second multimedia 110. In one embodiment, a part of a multimedia includes an image, text, or a combination thereof. In the embodiment, the multimedia includes a video or an animation.

Referring back to FIG. 5C, a user selects object 152 by touching a section of display screen 270 with finger 144. The object 152 is displayed in the section. Input detector 204 generates a detection signal 340 in response to determining that the selection of object 152 is made. The ADC 276 converts the detection signal 340 from an analog form to a digital form to generate an input signal 342. Processor 206 receives the input signal 342 and executes the instruction 132₅ to determine to display the second multimedia 110, which is shown in FIG. 5B. Upon executing the instruction 132₅, the processor 206 is directed to execute the portion 128₂. Processor 206 executes the portion 128₂ to display the second multimedia 110 on display screen 270.

In some embodiments, processor 206 receives the input signal 342 and executes the instruction 132₅ to determine to display one or more parts of the second multimedia 110.

Referring back to FIG. 5B, a user selects object 157 by touching a section of display screen 270 with finger 144. The object 157 is displayed in the section. Input detector 204 generates a detection signal 402 in response to determining that the selection of object 157 is made. The ADC 276 converts the detection signal 402 from an analog form to a digital form to generate an input signal 404. Processor 206 receives the input signal 404 and executes the instruction 132₆ to determine to display the first multimedia 106, which is shown in FIG. 5A. Upon executing the instruction 132₆, the processor 206 is directed to execute the portion 128₁. Processor 206 executes the portion 128₁ to display the first multimedia 106 on display screen 270.

In some embodiments, upon executing the instruction 132₆, processor 206 receives the input signal 404 and executes the instruction 132₆ to determine to display one or more parts of the first multimedia 106.

It should be noted that in some embodiments, processor 206 applies an aspect ratio during execution of portions 128₂, 128₃ and 128₄. For example, an aspect ratio of the second multimedia 110 is the same as the aspect ratio of the part 120 and the aspect ratio of the part 126. In various embodiments, processor 206 applies different aspect ratios during execution of portions 128₂, 128₃ and 128₄. For example, an aspect ratio of the second multimedia 110 is different than an aspect ratio of the part 120 and/or than an aspect ratio of the part 126.

It should further bet noted that a reference between an instruction and a portion is made by using one or more frame numbers or one or more time codes. In some embodiments, each frame is identified by a frame number or a time code by a processor. The processor renders a display of the frame based on an instruction by using either the frame number or the time code.

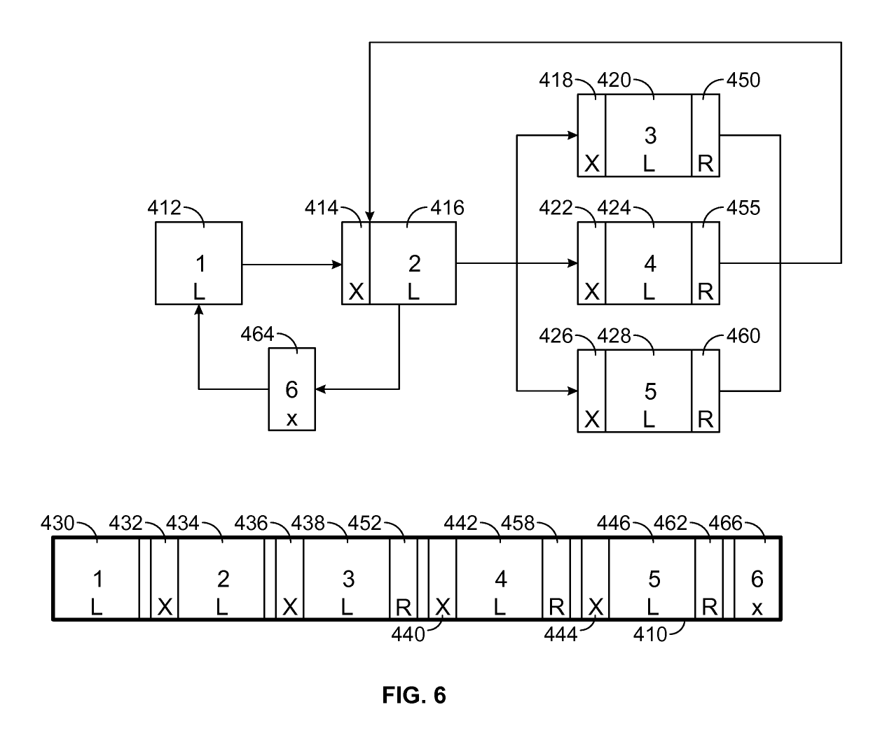

FIG. 6 is a diagram illustrating a method of displaying multimedia by executing various portions of a multimedia file 410. A multimedia 412 is displayed on display screen 270. In some embodiments, the multimedia 412 is displayed within a web page or a search results page, which is displayed on the display screen 270. A portion 430 of the multimedia file 410 is executed by a processor to display the multimedia 412. When an input indicating a selection from a user of the multimedia 412 is received, a lead in transition 414 is displayed on the display screen 270. In one embodiment, a lead in transition facilitating a transition from the current multimedia to the next multimedia is rendered by applying a higher number of graphical elements of the current multimedia than that of the next multimedia. A portion 432 of the multimedia file 410 is executed by a processor to display the lead in transition 414. After the lead in transition 414, a multimedia 416 is displayed on the display screen 416. A portion 434 of the multimedia file 410 is executed by a processor to display the multimedia 416. The multimedia 416 includes three multimedia objects. In several embodiments, the multimedia 416 includes any number of multimedia objects.

When an input indicating a selection from a user of a first of the three multimedia objects is received, a lead in transition 418 is displayed on the display screen 270. A portion 436 of the multimedia file 410 is executed by a processor to display the transition 418. After the lead in transition 418, a multimedia 420 is displayed on the display screen 270. A portion 438 of the multimedia file 410 is executed by a processor to display the multimedia 420. The multimedia 420 includes a close object.

Moreover, when an input indicating a selection from a user of a second of the three multimedia objects is received, a lead in transition 422 is displayed on the display screen 270. A portion 440 of the multimedia file 410 is executed by a processor to display the transition 422. After the lead in transition 422, a multimedia 424 is displayed on the display screen 270. A portion 442 of the multimedia file 410 is executed by a processor to display the multimedia 424. The multimedia 424 includes a close object.

Also, when another input indicating a selection from a user of a third of the three multimedia objects is received, a lead in transition 426 is displayed on the display screen 270. A portion 444 of the multimedia file 410 is executed by a processor to display the transition 426. After the lead in transition 426, a multimedia 428 is displayed on the display screen 270. A portion 446 of the multimedia file 410 is executed by a processor to display the transition 424. The multimedia 428 includes a close object.

Moreover, when an input indicating a selection from a user of the close object within the multimedia 420 is received, a lead out transition 450 is displayed on the display screen 270. In one embodiment, a lead out transition facilitating a transition from the current multimedia to the next multimedia is rendered by applying a higher number of graphical elements of the next multimedia than that of the current multimedia. A portion 452 of the multimedia file 410 is executed by a processor to display the lead out transition 450. After the lead out transition 450, the multimedia 416 is displayed on the display screen 270.

When an input indicating a selection from a user of the close object within the multimedia 424 is received, a lead out transition 455 is displayed on the display screen 270. A portion 458 of the multimedia file 410 is executed by a processor to display the lead out transition 455. After the lead out transition 455, the multimedia 416 is displayed on the display screen 270.

Also, when an input indicating a selection from a user of the close object within the multimedia 428 is received, a lead out transition 460 is displayed on the display screen 270. A portion 462 of the multimedia file 410 is executed by a processor to display the lead out transition 460. After the lead out transition 460, the multimedia 416 is displayed on the display screen 270.

The multimedia 416 includes a close object. When an input indicating a selection from a user of the close object within the multimedia 416 is received, a transition 464 is displayed on the display screen 270. A portion 466 of the multimedia file 410 is executed by a processor to display the transition 464. After the transition 464, the multimedia 412 is displayed on the display screen 270. In various embodiments, after the transition 464, multimedia 412 is displayed within a web page or a search results page on the display screen 270. The web page or the search results page is the same as that displayed before the display of the multimedia 416.

In some embodiments, one or more of the transitions 414, 418, 422, 426, 450, 455, 460, and 464 are excluded. For example, the multimedia 416 is displayed after displaying the multimedia 412 without displaying the transition 414. As another example, the multimedia 420 is displayed after displaying the multimedia 416 without displaying the transition 418.

The graph provided in FIG. 6 illustrates that the transitions can be organized and executed in any number of formats. Thus, the graph is a logic graph that custom defines the transitions for the multimedia presentation. In one embodiment, the logic graph identifies a non-linear presentation of the single multimedia file. In contrast to traditional video files, which are played logically from start to end, the single file, in one embodiment, allows for logic to define non-linear jumps to one region of the single file to another region. The regions can be identified, for example, based on time stamps along the frames of the single media file.

The design of the transition jumps provided by the graph of FIG. 6 is only one design choice, and the graph can be modified to provide transitioning or jumping from one multimedia object to another multimedia object of the single file 410. In one embodiment, the single file provides for ease of management of the file, while distinct video content is provided in each multimedia object (e.g., 1, 2, 3, 4, 5, 6, and the X/R transitions). Again, the single file has all of the distinct multimedia objects (segments) integrated as a single file, and the logic defined by the graph defines the navigation paths, based on user selection inputs made when interfacing with each of the multimedia segments.

Furthermore, each segment, in one embodiment, is allowed to loop while the user is viewing the segment. The looping is designed so that the user feels that a running video is playing, when in fact, the same motions are repeated until the user moves, transitions or jumps to another segment. In one embodiment, the first segment can be presented alongside content of a website. For instance, the first segment can be in the form of a scene, where people or objects move in accordance with a video segment loop of the single file.

The multimedia file, in one embodiment, is transmitted to the cache of the device accessing the web site on which the multimedia file is to be rendered, presented or interacted with during presentation. The transmission, in embodiment, can be in the form of background transmission, transfer, download or receipt, and the file, once cached (either entirely or partially), can be rendered.

The rendering is, in one embodiment, as a picture, a video or a combination of fixed images and moving images. In one embodiment, no moving images or objects are presented, and in others, multiple objects or people or characters, can move at the same time, consistent with the content of at least the initial multimedia object to be first presented on the page/display of the device. As noted herein, the display can take on many forms and can be rendered on many types of devices, such as mobile smartphones, tablet computers, laptops, computer monitors, television displays, dropdown displays, etc. Interfacing can be by way of a pointer mouse, a finger of a user, multiple fingers, gesture input (contact or no contact), tap input, etc.

Once the user interfaces with the scene, the scene can open up to a larger presentation format, and follow the presentation logic defined by the logic graph. In still another embodiment, the video segments (multimedia objects) of the file can present content for advertising purposes, while the presentation is more in the context of a video scene with interactivity. The multimedia presentation can appear, for instance, on a page of an online magazine, a news page, a game, or some other content provided by a site or combination of sites.

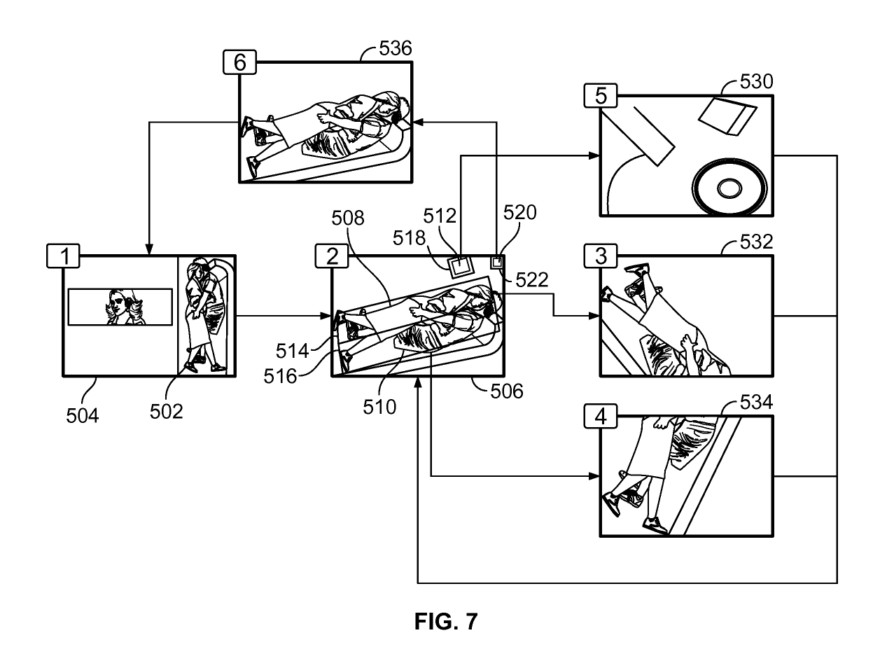

FIG. 7 is a block diagram illustrating a method of displaying multimedia by executing various portions of a multimedia file. As shown, multimedia 502 is displayed on a web page 504 on the display screen 270. When an input indicating a selection of the multimedia 502 is received, a multimedia 506 is displayed on the display screen 270. Multimedia 506 includes a multimedia object 508, a multimedia object 510, a multimedia object 512, and a close object 520. An overlay 514 is displayed as surrounding the multimedia object 508. Moreover, another overlay 516 is displayed as surrounding the multimedia object 510. Another overlay 518 is displayed as surrounding the multimedia object 512. Also, another overlay 522 is displayed as surrounding the close object 520.

When the multimedia object 512 is selected by a user, a multimedia 530 is displayed. Moreover, when the multimedia object 508 is selected by a user, a multimedia 532 is displayed. Also, when the multimedia object 510 is selected by a user, a multimedia 534 is displayed.

Moreover, when a close object within multimedia 530, a close object within multimedia 532, or a close object within multimedia 534 is selected by a user, the multimedia 506 is displayed. Also, when the multimedia object 520 is selected by a user, a multimedia 536 is displayed. When a close object within the multimedia 536 is selected by a user, the web page 504 is displayed.

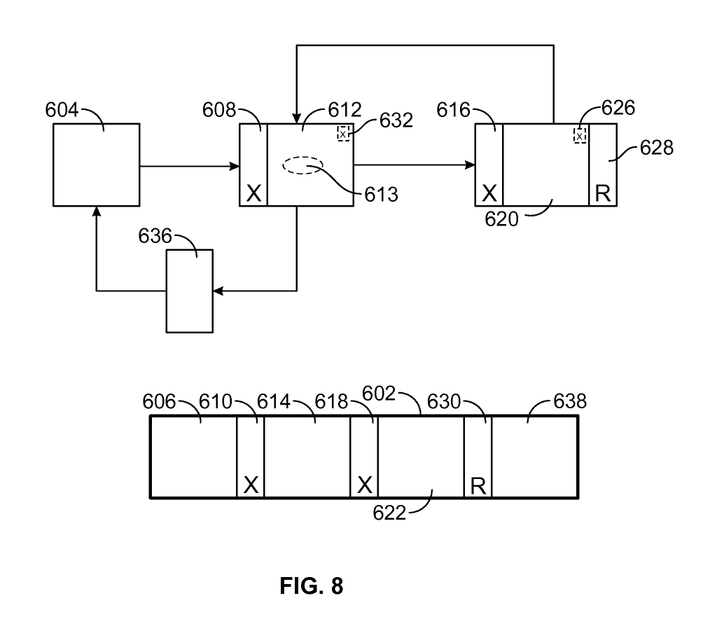

FIG. 8 is a diagram illustrating a method of displaying multimedia by executing various portions of a multimedia file 602. A multimedia 604 is displayed on display screen 270. In some embodiments, the multimedia 604 is displayed within a web page or a search results page, which is displayed on the display screen 270. A portion 606 of the multimedia file 602 is executed by a processor to display the multimedia 604. When an input indicating a selection from a user of the multimedia 604 is received, a lead in transition 608 is displayed on the display screen 270. A portion 610 of the multimedia file 602 is executed by a processor to display the lead in transition 608. After the lead in transition 608, a multimedia 612 is displayed on the display screen 270. A portion 614 of the multimedia file 602 is executed by a processor to display the multimedia 612. The multimedia 612 includes a multimedia object 613. In several embodiments, the multimedia 612 includes any number of multimedia objects.

When an input indicating a selection from a user of the multimedia object 613 is received, a lead in transition 616 is displayed on the display screen 270. A portion 618 of the multimedia file 410 is executed by a processor to display the lead in transition 616. After the lead in transition 616, a multimedia 620 is displayed on the display screen 270. A portion 622 of the multimedia file 602 is executed by a processor to display the multimedia 620. The multimedia 620 includes a close object 626.

Moreover, when an input indicating a selection from a user of the close object 626 is received, a lead out transition 628 is displayed on the display screen 270. A portion 630 of the multimedia file 602 is executed by a processor to display the lead out transition 628. After the lead out transition 628, the multimedia 612 is displayed on the display screen 270.

When an input indicating a selection from a user of a close object 632 within the multimedia 424 is received, a lead out transition 636 is displayed on the display screen 270. A portion 638 of the multimedia file 602 is executed by a processor to display the lead out transition 636. After the lead out transition 636, the multimedia 604 is displayed on the display screen 270. In various embodiments, after the transition 636, multimedia 604 is displayed within a web page or a search results page on the display screen 270 after the transition 636. The web page or the search results page is the same as that displayed before the display of the multimedia 612.

In some embodiments, one or more of the transitions 608, 616, 626, and 636 are excluded. For example, the multimedia 612 is displayed after displaying the multimedia 604 without displaying the transition 608. As another example, the multimedia 620 is displayed after displaying the multimedia 612 without displaying the transition 616.

It should be noted that although all portions are described above as being located within a single multimedia file, in various embodiments, one or more of the portions are located within the multimedia file and the remaining of the portions are located within other one or more multimedia files.

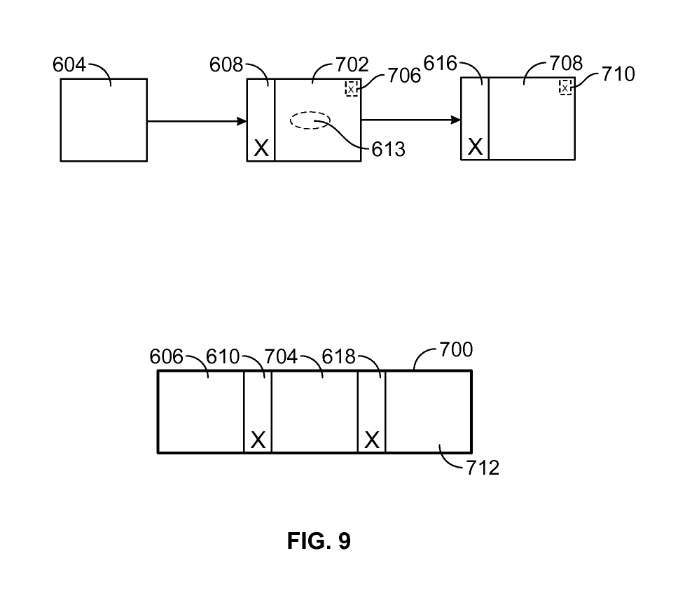

FIG. 9 is a diagram illustrating a method of displaying multimedia by executing various portions of a multimedia file 700. Multimedia 604 and lead in transition 608 are displayed in the same manner as that described above with reference to FIG. 8. Moreover, after the lead in transition 608, a multimedia 702 is displayed on the display screen 270. A portion 704 of the multimedia file 700 is executed by a processor to display the multimedia 702. The multimedia 702 includes the multimedia object 613. In several embodiments, the multimedia 702 includes any number of multimedia objects. The multimedia 702 further includes a close object 706.

When an input indicating a selection from a user of the multimedia object 613 is received, the lead in transition 616 is displayed on the display screen 270. A portion 618 of the multimedia file 700 is executed by a processor to display the lead in transition 616. After the lead in transition 616, a multimedia 708 is displayed on the display screen 270. A portion 712 of the multimedia file 700 is executed by a processor to display the multimedia 708. The multimedia 708 includes a close object 710.

Moreover, when an input indicating a selection from a user of the close object 706 is received, the multimedia 702 is not displayed on the display screen 270. In one embodiment, a graphical window that includes the multimedia 702 closes. After the closure of the multimedia 702, in one embodiment, a desktop screen is displayed by a processor on the display screen 270. In another embodiment, after the closure of the multimedia 702, an application window is displayed on the display screen 270.

When an input indicating a selection from a user of the close object 710 is received, the multimedia 708 is not displayed on the display screen 270. In one embodiment, a graphical window that includes the multimedia 708 closes. After the closure of the multimedia 708, in one embodiment, a desktop screen of an application window is displayed by a processor on the display screen 270.

In some embodiments, one or more of the transitions 608 and 616 are excluded. For example, the multimedia 702 is displayed after displaying the multimedia 604 without displaying the transition 608. As another example, the multimedia 708 is displayed after displaying the multimedia 702 without displaying the transition 616.

It should be noted that in the embodiment of FIG. 9, there is no loop back to multimedia 702 when the close object 710 is selected. The loop back occurs in the embodiment of FIG. 8 when the close object 626 is selected in FIG. 8. In FIG. 8, the loop back occurs to display the multimedia 612 when the close object 626 is selected. In various embodiments, the loop back to the multimedia 702 occurs when the close object 710 is selected.

Moreover, it should be noted that in the embodiment of FIG. 9, there is no loop back to multimedia 604 when the close object 706 is selected. The loop back occurs in the embodiment of FIG. 8 when the close object 632 is selected in FIG. 8. In FIG. 8, the loop back occurs to display the multimedia 604 when the close object 632 is selected. In various embodiments, the loop back to the multimedia 604 occurs when the close object 706 is selected.

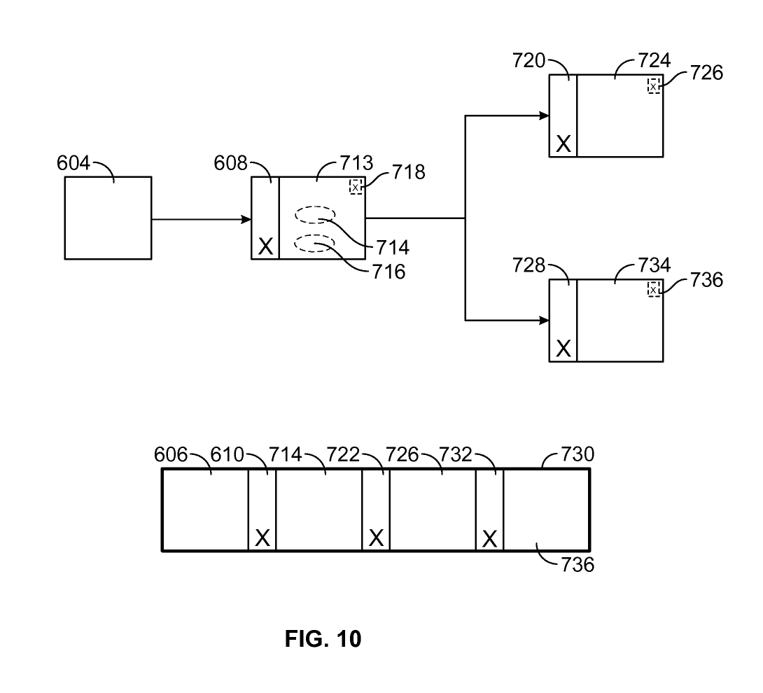

FIG. 10 is a diagram illustrating a method of displaying multimedia by executing various portions of a multimedia file 730. Multimedia 604 and lead in transition 608 are displayed in the same manner as that described above with reference to FIG. 8. Moreover, after the lead in transition 608, a multimedia 713 is displayed on the display screen 270. A portion 714 of the multimedia file 700 is executed by a processor to display the multimedia 713. The multimedia 713 includes a multimedia object 714 and a multimedia object 716. In several embodiments, the multimedia 702 includes any number of multimedia objects. The multimedia 713 further includes a close object 718.

When an input indicating a selection from a user of the multimedia object 714 is received, the lead in transition 720 is displayed on the display screen 270. A portion 722 of the multimedia file 730 is executed by a processor to display the lead in transition 720. After the lead in transition 720, a multimedia 724 is displayed on the display screen 270. A portion 726 of the multimedia file 730 is executed by a processor to display the multimedia 724. The multimedia 724 includes a close object 726.

Moreover, when an input indicating a selection from a user of the close object 726 is received, the multimedia 724 is not displayed on the display screen 270. In one embodiment, a graphical window that includes the multimedia 724 closes. After the closure of the multimedia 724, in one embodiment, a desktop screen is displayed by a processor on the display screen 270. In another embodiment, after the closure of the multimedia 724, an application window is displayed on the display screen 270.

Moreover, when an input indicating a selection from a user of the multimedia object 716 is received, the lead in transition 728 is displayed on the display screen 270. A portion 732 of the multimedia file 730 is executed by a processor to display the lead in transition 728. After the lead in transition 728, a multimedia 734 is displayed on the display screen 270. A portion 736 of the multimedia file 730 is executed by a processor to display the multimedia 734. The multimedia 734 includes a close object 736.

When an input indicating a selection from a user of the close object 736 is received, the multimedia 734 is not displayed on the display screen 270. In one embodiment, a graphical window that includes the multimedia 734 closes. After the closure of the multimedia 734, in one embodiment, a desktop screen is displayed by a processor on the display screen 270. In another embodiment, after the closure of the multimedia 734, an application window is displayed on the display screen 270.

It should be noted that in the embodiment of FIG. 10, there is no loop back to multimedia 713 when the close object 726 or close object 736 is selected. In various embodiments, the loop back to the multimedia 713 occurs when the close object 726 or close object 736 is selected.

Moreover, it should be noted that in the embodiment of FIG. 10, there is no loop back to multimedia 604 when the close object 718 is selected. In various embodiments, the loop back to the multimedia 604 occurs when the close object 718 is selected.

It should be noted that although all portions are described above as being located within a single multimedia file, in various embodiments, one or more of the portions are located within the multimedia file and the remaining of the portions are located within other one or more multimedia files.

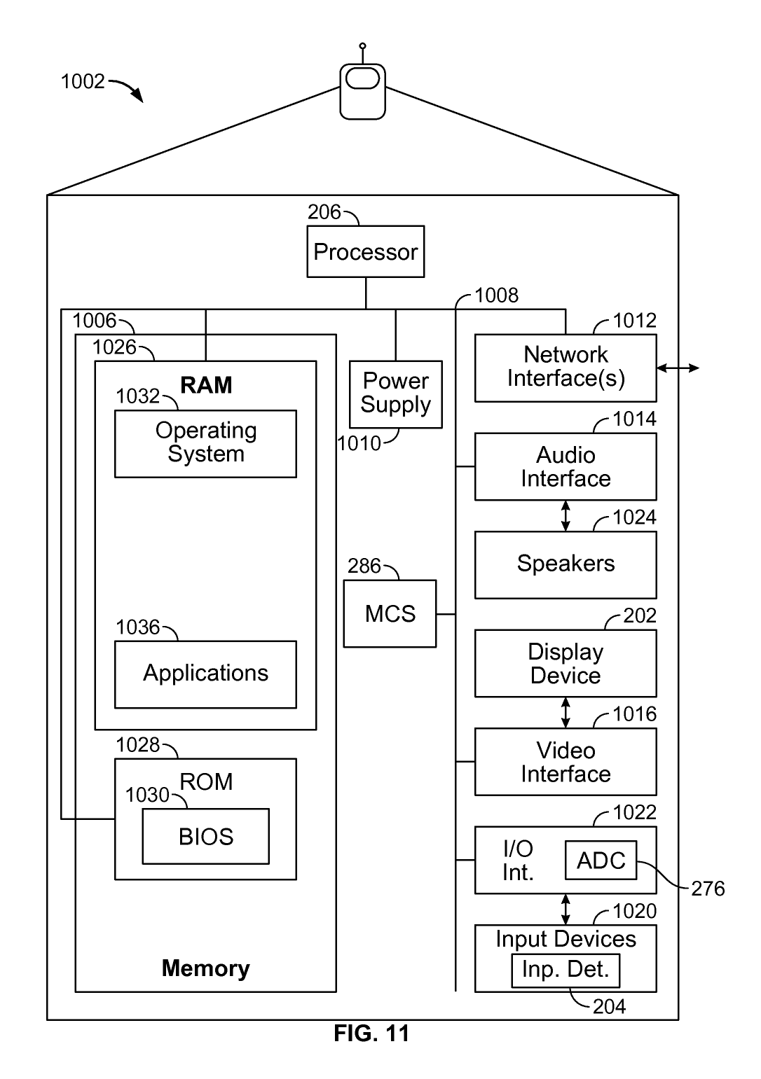

FIG. 11 shows one embodiment of computing device 1002 that may be included in a system implementing the invention. Computing device 1002 may include more or less components than those shown in FIG. 11.

As shown in FIG. 11, computing device 1002 includes the processor 206 in communication with a mass memory 1006 via a bus 1008. Computing device 1002 also includes a power supply 1010, one or more network interfaces 1012, an audio interface 1014, video interface 1016, display device 202, one or more input devices 1020, and an input/output (I/O) interface 1022. Power supply 1010 provides power to computing device 1002. In one embodiment, a rechargeable or non-rechargeable battery is used to provide power. In some embodiments, the power is provided by an external power source, such as an alternating current (AC) adapter or a powered docking cradle that supplements and/or recharges a battery.

Computing device 1002 may optionally communicate with a base station (not shown), or directly with another computing device. Network interface 1012 includes circuitry for coupling computing device 1002 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), short message service (SMS), general packet radio service (GPRS), ultra wide band (UWB), Institute of Electrical and Electronics Engineers (IEEE) 802.16 Worldwide Interoperability for Microwave Access (WiMax), or any of a variety of other wireless communication protocols. Network interface 1012 is sometimes known as a transceiver, transceiving device, or network interface card (NIC).

Audio interface 1014 is arranged to provide audio data and/or receive audio signals, such as, a sound. For example, audio interface 1014 may be coupled to speakers 1024 that output audio signals. As another example, the audio interface 1014 is coupled to a microphone to receive audio signals. In one embodiment, the speakers 1024 convert audio data into audio signals. In some embodiments, audio interface 1014 includes an analog-to-digital converter to convert audio signals into audio data.

Display device 202 may be an LCD display, plasma display, LED display, or any other type of display used with a computing device. In some embodiments, display device 202 includes a touch sensitive screen arranged to receive input from an input device, such as a stylus, or from finger 144.

In one embodiment, instead of the processor 206 executing a renderer software program that converts multimedia data to display, such as render, multimedia, the video interface 1016 includes a graphical processing unit (GPU) that performs the execution. In some embodiments, the renderer software program is stored in mass storage 1026.

Input devices 1020 includes one or more input devices arranged to receive input from a user. For example, input devices 1020 include input detector 204, a mouse and a keyboard.

Computing device 1002 also includes I/O interface 1022 for communicating with external devices, such as a headset, or other input or output devices. In some embodiments, I/O interface 1022 utilizes one or more communication technologies, such as universal serial bus (USB), infrared, Bluetooth™, or the like. In various embodiments, I/O interface 1022 includes ADC 276.

Mass memory 1006 includes a RAM 1026 and a ROM 1028. Mass memory 1006 illustrates another example of computer storage media for storage of information such as computer readable instructions, data structures, program modules or other data. Mass memory 1006 stores a basic input/output system (“BIOS”) 1030 for controlling low-level operation of computing device 1002. The mass memory 1006 also stores an operating system 1032 for controlling the operation of computing device 1002. It will be appreciated that in one embodiment, the operating system includes UNIX, LINUX™, or Windows Mobile™ operating system.

RAM 1026 further includes applications 1036 and/or other data. Applications 1036 may include computer executable instructions which, when executed by computing device 1002, provide functions, such as, rendering, filtering, and analog-to-digital conversion. In one embodiment, the processor 206 retrieves information, such as a portion of a multimedia or an instruction from MCS 286 with a speed higher than that used to retrieve information from mass storage 1026.

It should be noted that although some of the above embodiments are described using a single display screen of a display device, in some embodiments, the methods described herein are performed using multiple display screens of a single display device or multiple display screens of multiple display devices. It should further be noted that although some of the operations described above are performed by a single processor, in some embodiments, an operation is performed by multiple processors or multiple operations are performed by multiple processors.

Although various embodiments of the present invention have been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for rendering a multimedia presentation on a device connected to the internet, the multimedia presentation illustrated on a page associated with a website served over the internet, the method comprising:
transferring the multimedia presentation to the device upon detection that the page of the website is accessed using the device, the multimedia file being a single multimedia file with a plurality of multimedia objects, the multimedia presentation to be rendered from an initial multimedia object, the multimedia presentation including a logic graph that defines paths for traversing the plurality of multimedia objects of the single multimedia file in response to detected interfaces with one or more of the plurality of multimedia objects,
wherein the method is executed by a processor.

2. The method of claim 1, wherein the initial multimedia object is configured for presentation along with content of the page associated with the website.

3. The method of claim 2, wherein the content of the page is main content from the website, and the multimedia presentation is associated with an advertising context.

4. The method of claim 3, wherein the main content is associated with one or more online magazine compilations.

5. The method of claim 1, wherein the logic graph identifies a non-linear presentation of the single multimedia file.

6. A method for displaying multimedia, comprising:
displaying a first multimedia;
determining whether a first input indicating a selection of the first multimedia is received;
displaying a second multimedia in response to receiving the first input, wherein the second multimedia includes a first multimedia object and a second multimedia object; determining whether a second input indicating a selection of the first multimedia object or a third input indicating a selection of the second multimedia object is received;
displaying a third multimedia in response to determining that the second input is received; and
displaying a fourth multimedia in response to determining that the third input is received, wherein the second, third, and fourth multimedia are displayed based on a logic graph.

7. The method of claim 6, further comprising:
executing a first portion of a multimedia file to display the first multimedia; and
executing a second portion of the multimedia file to display the second multimedia.

8. The method of claim 7, further comprising executing a third portion of the multimedia file to display the third multimedia, wherein said executing a third portion is performed in response to determining that the second input is received.

9. The method of claim 8, further comprising executing a fourth portion of the multimedia file to display the fourth multimedia, wherein said executing a fourth portion is performed in response to determining that the third input is received.

10. The method of claim 9, wherein each of the first portion, second portion, third portion, and fourth portion includes animation data or video data.

11. The method of claim 6, wherein said displaying a first multimedia comprises displaying the first multimedia within a web page.

12. The method of claim 6, wherein said display a first multimedia comprises displaying a first advertisement multimedia.

13. The method of claim 6, wherein said determining whether a second input or a third input is received comprises determining whether a touch input indicating a selection of the first multimedia is received from a user.

14. The method of claim 6, further comprising displaying a first transition between said displaying the first multimedia and said displaying the second multimedia, wherein said displaying a first transition is performed in response to receiving the first input.

15. The method of claim 14, further comprising displaying a second transition between said displaying the second multimedia and said displaying the third multimedia, wherein said displaying a second transition is performed in response to receiving the second input.

16. The method of claim 14, further comprising displaying a second transition between said displaying the second multimedia and said displaying the fourth multimedia, wherein said displaying a second transition is performed in response to receiving the third input.

17. The method of claim 6, wherein said displaying the third multimedia comprises displaying a part of the first multimedia object.

18. The method of claim 6, wherein said displaying the fourth multimedia comprises displaying a part of the second multimedia object.

19. The method of claim 6, wherein the third multimedia includes a third object, said method further comprising:
receiving a fourth input indicating a selection of the third object; and
displaying the second multimedia in response to receiving the fourth input.

20. The method of claim 19, wherein the second multimedia includes a fourth object, said method further comprising:
receiving a fifth input indicating a selection of the fourth object; and
displaying the first multimedia in response to receiving the fifth input.

21. The method of claim 6, wherein the fourth multimedia includes a third object, said method further comprising:
receiving a fourth input indicating a selection of the third object; and
displaying the second multimedia is response to receiving the fourth input.

22. A method for displaying multimedia, comprising:
displaying a first multimedia, wherein the first multimedia includes a first multimedia object and a second multimedia object;
determining whether a first input indicating a selection of the first multimedia object or a second input indicating a selection of the second multimedia object is received;
displaying a second multimedia in response to determining that the first input is received; and
displaying a third multimedia in response to determining that the second input is received, wherein the second and third multimedia are displayed based on a logic graph.

23. The method of claim 22, further comprising executing different portions of a multimedia file to display the first multimedia, the second multimedia, and the third multimedia.

24. A system for displaying multimedia, comprising:
a display for displaying a first multimedia;
an input detector for detecting a first input, the first input detected to detect a selection of the first multimedia, the display device for displaying a second multimedia in response to the detection of first input, the second multimedia including a first multimedia object and a second multimedia object; and
a processor for determining whether a second input indicating a selection of the first multimedia object or a third input indicating a selection of the second multimedia object is received, the display for displaying a third multimedia in response to the determination that the second input is received, the display device for displaying a fourth multimedia in response to the determination that the third input is received, the processor for applying a logic graph to display the second, third, and fourth multimedia.

25. The system of claim 24, wherein the processor is configured to execute a first portion of a multimedia file to display the first multimedia, the processor for executing a second portion of the multimedia file to display the second multimedia.
